(19) United States
(12) Patent Application Publication
(10) Pub. No.: US 2005/0054765 A1
(43) Pub. Date: Mar. 10, 2005

(54) Polyorganosiloxane compositions which can be painted or coated over

(75) Inventor: Markus Alexander Putzer, Leverkusen (DE)

Correspondence Address: Norris McLaughlin & Marcus, 30th Floor, 220 East 42nd Street, New York, NY, 10017, US

(73) Assignee: GE Bayer Silicones GmbH & Co KG, Leverkusen (DE)

(21) Appl. No.: 10/496,326

(22) PCT Filed: Nov. 20, 2002
(86) PCT No.: PCT/EP02/12965

(30) Foreign Application Priority Data
Nov. 21, 2001 (DE) 101 56 918.1

(51) Int. Cl. C08L 83/08

(52) U.S. Cl. 524/588

(57) ABSTRACT

The invention relates to a polyorganosiloxane composition, which is obtained by means of a method comprising the mixing and reacting of given components, a vulcanized elastic polyorganosiloxane composition, which is obtained by reacting the polyorganosiloxane compositions through contact with water or water vapor and the use of the vulcanized polyorganosiloxane compositions as joint sealings, adhesives, profiles, coatings or formed-in-place gaskets.

The invention relates to a polyorganosiloxane composition, to a method for mixing the components and a method for vulcanizing said polyorganosiloxane compositions, to the vulcanized composition thus obtainable, to composite materials that contain a substrate and said vulcanized composition, and to the use of the polyorganosiloxane composition.

The invention relates in particular to neutrally crosslinking, one-component silicone rubber mixtures that can be painted or coated over with conventional solvent- and water-based paints after application as well as after vulcanization, and that also have low volume shrinkage.

Polyorganosiloxane compositions, referred to below as RTV-1K (room temperature-vulcanizing single component) silicone rubber mixtures, are compositions that are ready to use and storable under moisture-free conditions, and that react to form elastomers only when moisture is admitted, with the release of cleavage products. Such polyorganosiloxane compositions have long been used for sealing joints in facade and window construction in the sanitary and industrial sectors. Some applications, particularly in the internal region or in facade construction, require paints to be applied on the silicone rubber mixtures or on the elastomer produced by vulcanization, while at the same time meeting the requirement for low volume shrinkage. Because of their widespread use, solvent- and water-based paints are of particular importance as paints. Interest in the latter paints has increased in recent years, since high volatility organic solvents can largely be dispensed with in the manufacture of water-based paints.

In general, silicone elastomers are not considered amenable to being painted or even coated, particularly with water. This school of thought is stated in U.S. Pat. No. 4,902,575, U.S. Pat. No. 4,906,707, U.S. Pat. No. 4,965,311, and U.S. Pat. No. 5,063,270. There are application examples in which specific use is made of the water-repellent character of silicone polymers. Thus, for the manufacture of polishing agents in the automobile industry, for example, the addition of silicone oils gives the polishing agents their water-repellent properties (U.S. Pat. No. 5,043,012). In U.S. Pat. No. 4,902,575, U.S. Pat. No. 4,906,707, U.S. Pat. No. 4,965,311, and U.S. Pat. No. 5,063,270, S. Yukimoto et al. describe crosslinkable compositions based on modified silicone (MS) polymers that have polymer frameworks built from polyethers such as polyethylene oxide and polypropylene oxide. These crosslinkable mixtures are described by S. Yukimoto et al. as amenable to coating with alkyd paints, but no information is given about contact with water-dilutable paints. Without the addition of antioxidants, which however can prevent drying of air-drying, oil-based paints, sealant materials based on MS polymers are not weather-resistant, and also are not comparable to silicone elastomers in their mechanical recovery properties. This has resulted in the need to search for compositions that can be painted or even coated over, particularly in the area of weather-resistant silicone rubber mixtures.

In U.S. Pat. No. 4,358,558 Shimizu has proposed a coatable polyorganosiloxane mixture that, in addition to an organoaminoxy compound as crosslinker, also contains low-molecular reactive alpha-alkynols (C≡C triple bond in addition to carbinol). These polyorganosiloxane mixtures are readily vaporized, sensitive to oxidation, and easily decomposed by bases, which limits their effectiveness. In DE 3 025 376 (filing date Jul. 4, 1980), Salttlegger et al. describe coatable organopolysiloxane molding compounds with the addition of short-chain paraffinic hydrocarbons. However, these compounds result in high volume shrinkage of the resulting vulcanizate. Furthermore, in DE 3 836 916 (filing date Oct. 17, 1989) Endres et al. describe coatable polydiorganosiloxane mixtures based on carboxylic acid amidoalkylalkoxysilicon compounds as crosslinkers, titanic acid esters, and precipitated hydrophobized chalks. These RTV-1K silicone rubber mixtures are not particularly stable in storage due to the high residual moisture content of precipitated chalks. The teaching that alpha, omega-trimethyl-terminated polydiorganosiloxanes have long-term adverse effects on the paintability and coatability with water-based paints is not mentioned in the cited document. In EP 0 618 257, O'Neill et al. describe neutrally crosslinking organopolysiloxane compositions that can be coated with various paints. The oxidatively crosslinking additives used by Schiller et al. have a detrimental effect, so that in EP 0 618 257 it is recommended that the sensitive additives be admixed only just before use (two-component system).

Silicone rubber mixtures that crosslink at room temperature and that contain linear polyorgansiloxane, fillers, aminoalkylsilanes as bonding agents, and silanes containing hydrolyzable groups as crosslinkers, in addition to optional condensation catalysts have been known for some time, and are proposed in EP 0 050 453, U.S. Pat. No. 4,490,500, U.S. Pat. No. 3,933,729, EP 000 929, and U.S. Pat. No. 4,760,123. However, none of these patents discloses information about the amenability to painting or even coating.

In DE 3 808 200, Schiller et al. propose one- or two-component compositions, based on branched organosiloxane chains, which can be painted or coated over. The disadvantage of these systems is the higher cost of producing the branched-chain organosiloxanes as well as the high tensile stresses at 100% elongation of 0.45 to 0.75 N/mm² (in accordance with DIN 53504), which, for many applications, are disadvantageous as joint sealant.

It is regarded as prior art that, by the selection of suitable radicals of polydiorganosiloxane that are more polar than alkyl radicals, or by an increased proportion of branched, i.e., T- or Q-siloxane unit-containing, polymers, the coatability may likewise be favorably influenced.

However, it is an object of the present invention to achieve coatability using economical, common raw materials, or to use organosiloxanes whose organic radicals R are economical and oxidation- and light-resistant.

The use of alkylaromatic compounds in silicone rubber mixtures is known, and is described for example in DE 2 908 036 (filing date Mar. 1, 1979). The alkylaromatic compounds are used here as economical additional additives, or as substitutes for the alpha, omega-trimethyl-terminated polydiorganosiloxanes otherwise used as softeners. The use of alkylaromatic compounds as softeners specifically in benzamide-crosslinking silicone rubber mixtures is described in greater detail in DE 4 415 396 (filing date May 3, 1994). However, neither of these patents contains information about the amenability to painting or coating of these silicone rubber mixtures, or of the silicone elastomers resulting from vulcanization, when the aromatic compounds described therein are used.

The object of the present invention is to provide polyorganosiloxane compositions that can be painted or coated over with solvent- or water-based paints after direct application as well as after vulcanization, and that do not have the disadvantages of the RTV-1K compositions described in the prior art, such as inadequate stability in storage and high volume shrinkage of the vulcanizate resulting from the use of greater quantities of short-chain, linear, or cyclic hydrocarbons, for example.

Unexpectedly, the above-described object is achieved by providing a polyorganosiloxane composition that can be obtained by a method comprising the mixture and reaction of the following components:
a) At least one crosslinkable polydiorganosiloxane,
b) Optionally, a filler for thickening or reinforcing,
c) At least one crosslinker selected from the group composed of oximosilane/-siloxane crosslinkers and benzamidosilane/-siloxane crosslinkers,
d) At least one aminoalkylalkoxysiloxane as crosslinker or bonding agent,
e) Optionally, an inert filler,
f) At least one organometallic catalyst,
g) Optionally for RTV-1K compositions, common auxiliary substances, and
h) 1 to 18% by weight alkylaromatic compounds, relative to the total quantity of the composition, having an average molar mass of 200 to 500 g/mol in the particular compound class, measured as a weight average (M_{w}), and a viscosity-density constant of at least 0.860.

The polyorganosiloxane compositions according to the invention preferably contain no alpha, omega-trimethyl-terminated polydiorganosiloxanes, which are free of reactive groups according to the definition of component a). The mixtures according to the invention with the claimed amounts of the selected hydrocarbons permit coating, with no increase in the volume shrinkage.

Surprisingly, the replacement of the alpha, omega-trimethyl-terminated polydiorganosiloxanes, typically used as softeners in silicone rubber mixtures, by 1 to 18% by weight of an alkylaromatic compound, relative to 100% by weight of the composition, having a molar mass of 200 to 500 g/mol and a viscosity-density constant of at least 0.860, results in polyorganosiloxane compositions that can be painted and coated over with solvent- and water-based paints after the direct application, i.e., before the crosslinking or vulcanization, as well as after the vulcanization, and that also have good paint adhesion. It was also surprising that this effect is found only in oximosilane and benzamidosilane/-siloxane-crosslinking systems. In contrast to the prior art, here, the use of oxidatively crosslinking additives that impair stability in storage can be omitted. Likewise, the use of cyclohexane, isohexane, isooctane, isohexadecane, isododecane, or isooctadecane as paraffinic hydrocarbons, which cause a high volume shrinkage of the corresponding vulcanizate, as well as branched polyorganosiloxane chains that are more expensive to manufacture can be dispensed with. The RTV-1K silicone rubber mixtures according to the invention are characterized by very good amenability to painting or coating with solvent- and water-based paints, after application as well as after vulcanization. The vulcanizates of the mixtures exhibit a low volume shrinkage (preferably less than approximately 8% by volume in accordance with ISO 10563). The polyorganosiloxane compositions according to the invention are stable in storage when air is excluded.

The crosslinkable polyorganosiloxanes (component a) of the composition used according to the invention preferably are those having general formula (I); 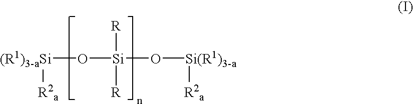
where R and R² independently represent optionally substituted C₁-C₁₀ alkyl, C₆-C₁₄ aryl, or C₂-C₁₀ alkenyl groups. R and R² may be the same or different. R may also stand for siloxane radicals containing the following groups: D=R²₂SiO, M=R¹₃₋ₐR²ₐSiO_{0.5}, T=R²SiO_{3.2}, and Q=SiO_{4/2}, whereby predominantly D groups are preferably present and the number of M groups is determined by the number of D, T, or Q groups, and on the number of ≡Si—O—R² or ≡Si—OH groups. The content of Si—O—R² is 0.04-10 mol %, and that of Si—OH, 0.04-2 mol %. Preferably used as siloxane polymers are linear diorganosiloxanes where R=methyl, whose polymerization rate may be derived in a known manner from the viscosity data, whereby the polydispersity of M_{w}/Mₙ , (average molecular weight/molecular number) should not be greater than 30. The polyorganosiloxanes may also be present as a mixture. Larger proportions of low-molecular, noncrosslinkable siloxanes impair the coatability.

For siloxane polymers containing T or Q units, it becomes increasingly difficult to prepare flowable polymers as the chain length increases. For this reason, the proportion of these units is limited to preferably less than 1% by weight for chain lengths of n>500. In the case of low-molecular siloxane polymers, polymers are still flowable with very high proportions (up to approximately 45% by weight) of Q or T units. In the event that such reactive polymers according to a) are mixed with the predominantly linear diorganosiloxane polymers, the proportion of these polymers, which then additionally contain T or Q units>1% by weight, should be limited to proportions of less than 30% by weight in component a).

The above-referenced R² radicals include optionally substituted C₁-C₁₀ alkyl groups comprising linear and branched alkyl groups containing 1 to 10 carbon atoms, such as, for example, methyl, ethyl, n-propyl, isopropyl, n-butyl, isobutyl, tert-butyl, pentyl, hexyl, heptyl, octyl, etc. Methyl and ethyl groups are preferred. Substituents of the above-referenced optionally substituted C₁-C₁₀ alkyl groups R² include fluorine in particular. Examples of the substituted alkyl groups are trifluoropropyl radicals, C₆F₁₃—CH₂CH₂—, C₃F₅—O—CH₂CH₂CH₂—, or fluoroxirane propyloxy-propyl.

The above-referenced optionally substituted R²C₆-C₁₄ aryl groups include aromatic groups containing 6 to 14 carbon atoms, such as for example phenyl or naphthyl, etc. Phenyl is preferred.

The above-referenced optionally substituted C₂-C₁₀ alkenyl groups include linear or branched alkenyl groups containing 2 to 10 carbon atoms, for example vinyl, allyl, hexenyl, octenyl, norbornenyl, or limonyl, etc. Vinyl is preferred.

The R¹ substituents, in each case independent of one another, are —OH or hydrolyzable groups, i.e., groups that react with water to form HO—Si groups, preferably oxime groups (—O—N═CR⁵₂) and benzamide groups (—N(R²)—C(═O)R⁵) and alkoxy groups (—OR²), where R² in each case is as defined above. The polymerization degree n is a whole number and can assume values of preferably 50 to 2500; i.e., for R=methyl,50 mPa.s to 800 Pa.s at 25° C., D=1 sec⁻¹, while a=0, 1, or 2.

The crosslinkable polyorganosiloxanes used according to the invention may optionally be produced in a separate process step or in situ in the preparation of the inventive polyorganosiloxane composition, for example by mixing an alpha, omega-trimethyl-terminated polyorganosiloxane with at least two equivalents of an oximosilane/-siloxane crosslinker or benzamidosilane/-siloxane crosslinker as component c), and reacting same at 0-100° C.

Furthermore, crosslinkable polyorganosiloxanes a) used according to the invention may also be obtained by reacting an alpha, omega-hydroxyl-terminated polyorganosiloxane with at least two equivalents of an aminoalkylalkoxysilane or -siloxane (component d).

The quantity of component a) in the polyorganosiloxane compositions according to the invention is preferably from 22 to 98.79% by weight, relative to the total mass of the composition a) through h).

The fillers, component b), include for example amorphous or crystalline, reinforcing hydrophobic or hydrophilic silicic acids with BET surfaces of 30 to 400 m²/g (Aerosil 130, 150, 200, R972, 974, HDK H20). These are reinforcing and thickening fillers. They allow the strength of the crosslinked rubber to be increased, and also allow the thickness and non-sagging of the non-crosslinked siloxane composition to be adjusted.

These are preferably hydrophobic silicic acids having BET surfaces of 90-200 m²/g in quantities of 0-15% by weight, preferably 1-7% by weight. The term “hydrophobic” includes all types of hydrophobization, such as that obtained with silanes, siloxanes, or C₁-C₃₀ fatty acid or fatty alcohol-fatty acid/alcohol ester derivatives or fatty acid amide derivatives, in addition to C₁-C₃₀ phosphoric acid esters.

The oximosilane/-siloxane crosslinkers or benzamidosilane/-siloxane crosslinkers (component c) used according to the invention are preferably organosilicon compounds containing at least two Si—O—N═CR⁵₅₂ and/or Si—N(R²)—C(═O)R⁵ groups, in particular organosilicon compounds of formula (II):
R⁴_{b}SiR³_{4-b} (II)
where the substituents R⁴=R² and, in each case, independent of one another, represent optionally substituted C₁-C₁₀ alkyl, C₆-C₁₄ aryl, or C₂-C₁₀ alkenyl groups, and the R³ substituents represent hydrolyzable groups, with the stipulation that at least two R³ radicals represent an oxime group (—O—N═CR⁵₂) and/or a benzamide group (—N(R²)—C(═O)R⁵). The index b is a whole number and can assume the values 0, 1, or 2, whereby the R⁴ substituent has the meaning described above, and may be the same or different if multiple R⁴ substituents are present. For the case that at least one R³ substituent is a benzamide group (—N(R²)—C(═O)R⁵), R³ in particular may also represent an alkoxy group (—OR²).

The hydrolyzable reactive groups may be present in one molecule as well as in an oligopolymeric or polymeric siloxane. Such siloxanes are preferably condensation products.

Condensation products of these crosslinkers are produced for example by adding water, siloxane diols, or silanols (SiOH-functionalized linear or branched polysiloxanes) under self-catalysis or catalysis by various crosslinkers (component c) with one another, i.e., the oximosilane/ siloxane crosslinkers, the benzamidosilane/siloxane crosslinkers, or the aminoalkylalkoxysilanes/siloxanes (component d) that are used in the composition according to the invention.

Alcohols, hydroxylamines, or benzamides are released as reaction product in this condensation.

The oximosilane/-siloxane crosslinkers (component c) are particularly preferably tris(methylethylketoximo)vinyl silane and methyl-tris(methylethylketoximo) silane.

The benzamidosilane/siloxane crosslinkers are particularly preferably bis(N-methylbenzamido)-ethoxymethylsilane.

The quantity of oximosilane/-siloxane crosslinkers or benzamidosilane/-siloxane crosslinkers used according to the invention in the inventive composition is preferably at least approximately 1.0% by weight, particularly preferably at least approximately 2.0% by weight. The maximum proportion is approximately 30% by weight, preferably approximately 10% by weight, resulting in the following preferred ranges: from 1.0% by weight to 30% by weight, particularly preferably 2.0% by weight to 10% by weight, in each case relative to the total quantity of the composition according to the invention.

The aminoalkylalkoxysilanes/siloxanes (component d) used according to the invention are preferably those having the general formula (III) and (IV):
X—(CH₂)_{c}—Si(OR⁶)₃ (III)
X—(CH₂)_{c}—Si(OR⁶)₂—O[Me₂SiO]ₙSi(OR⁶)₂—(CH₂)_{c}—X (IV)
where X is selected from —NH₂, —NHR⁶, —NR⁶₂—NHCH₂CH₂NH₂, and the R⁶ substituents in each case independently represent optionally substituted linear or cyclic C₁-C₁₀ alkyl, C₆-C₁₄ aryl, C₂-C₁₀ alkenyl, or siloxane groups. The index c is a whole number and may assume values preferably between 2 and 10, and c very particularly is preferably equal to 3. The values for n lie between 1 and 50, preferably between 4 and 7. Aminoalkylalkoxysiloxanes in the present formula, in which R⁵ represents a siloxane group, are obtained for example by condensation of the referenced compounds with one another in the presence of water or siloxane diols or SiOH-functionalized linear or branched polysiloxanes, silanols, and catalyst, with the elimination of alcohol.

Mixtures of aminoalkylalkoxysilanes/siloxanes may also be used.

Aminopropyltrialkoxysilanes and alpha, omega-(diethoxy-3-propylamine)-terminated polydimethoxysiloxanes are particularly preferred, and aminopropyltrimethoxysilane, aminopropyltriethoxysilane, and alpha, omega-(diethoxy-3-propylamine)-terminated dodecamethylhexasiloxane are very particularly preferred.

The quantity of aminoalkylsiloxanes d) used according to the invention in the inventive composition is preferably at least approximately 0.1% by weight, particularly preferably at least approximately 0.2% by weight. The maximum proportion is approximately 30% by weight, preferably approximately 20% by weight, resulting in the following preferred ranges: from 0.1% by weight to 30% by weight, particularly preferably 0.2% by weight to 20% by weight, in each case relative to the total quantity of the composition a)-h) according to the invention.

The inert filler as component e) comprises the silicates, oxides, carbonates, or silicic acids that have little or no reinforcing or thickening effect. The BET surfaces are 0.3-30 m²g, preferably 1-10 m²/g, and the maximum particle size is 100 μm. The inert fillers are used in quantities of 0-65% by weight relative to the components a) through h), preferably 0-40% by weight. In addition, the fillers are preferably hydrophobic, i.e., surface-treated with silanes, siloxanes, silazanes, or in particular for chalks with C₁-C₃₀ fatty acid or fatty alcohol-fatty acid/alcohol ester or fatty acid amide derivatives, preferably stearic acids, or C₁-C₃₀ phosphoric acid esters.

Examples of the catalysts as component f) include the following: organotin compounds, organotitanium compounds, and organozirconium compounds. Preferred organotin compounds are dioctyl tin oxide, dibutyl tin oxide, dimethyl tin oxide, dimethyl tin dichloride, dibutyl tin dichloride, tributyl tin chloride, dibutyl tin dilaurate, dibutyl tin diacetate, dibutyl tin maleate, dibutyl tin dihexanoate, dibutyl tin dioctoate, dioctyl tin dioctoate, dioctyl tin dilaurate, dioctyl tin butoxy stannane, and/or tributylethoxy stannane. In addition, reaction products of the above-described organotin compounds with one or more optionally substituted silicic acid esters, polysilicic acid esters, organylalkoxysilanes, and/or their respective partial hydrolysates may be used as tin-containing catalysts.

However, chelates of calcium and of zinc may also be used.

Preferred organotitanium compounds are titanium chelate catalysts. These are known as such and are described for example in U.S. Pat. No. 4,680,364, U.S. Pat. No. 3,689,454, U.S. Pat. No. 3,334,067, DE 19507416, and U.S. Pat. No. 4,438,039. The quantity of catalyst f) in the compositions according to the invention is preferably 0.01 to 5% by weight, in each case relative to the total mass of the inventive composition a) through h).

Dialkyl tin carboxylates are preferred, particularly preferably dialkyl tin carboxylates with polysilicic acid esters, or dibutyl tin oxide and aminopropyltrimethoxysilane or Ti-chelate, preferably bis(1,3-propanedioxy)-titanium(IV)acetylacetonate ethylacetoacetate.

The alkylaromatic compounds (component h) used according to the invention, having an average molar mass of 200 to 500 g/mol, include individual compounds or mixtures (including isomeric mixtures) of optionally substituted alkylbenzenes, alkylnaphthenes, alkylanthracenes, alkylnaphthacenes, alkylindenes, and alkylfluorenes. The aromatic compounds may be singly or multiply substituted with alkyl groups. The alkyl groups themselves may be linear or branched. Preferred are pure substances or mixtures (including isomeric mixtures) of alkylbenzenes.

The alkylaromatic compounds as component h) preferably have a viscosity-density constant (VDC) of at least 0.860. The viscosity-density constants (VDC) of the alkylaromatic compounds here were determined from the aniline points according to the following equation (Handbuch der Gummiindustrie [Rubber Industry Handbook], 2nd Ed., Bayer A G, Rubber Division, Leverkusen, 1991):
VDC=(1196−aniline point in ° F)/1170

The aniline points themselves were determined in accordance with ASTM D 611. Preferred alkylaromatic compounds are isomeric mixtures of linear and branched monoalkylbenzenes, isomeric mixtures of essentially linear dialkylbenzenes, or isomeric mixtures of branched-chain mono- and di- and trialkylbenzenes, etc.

For the alkylaromatic compounds according to the invention, it is not sufficient to select these solely according to the molecular weight. Rather, at the same time, the selection must be made according to the VDC criterion, in order to obtain compositions that can be coated over or painted and that, at the same time, have a low volume shrinkage.

The alkylaromatic compounds used according to the invention, having an average molar mass of 200 to 500 g/mol (component h), are contained in the inventive composition in quantities of 1 to 18% by weight, preferably 2 to 15% by weight, relative to the total quantity of the composition.

The molecular weight was determined as the weight average M_{w} by the use of gel chromatography (GPC).

In addition to the referenced essential components a) through f), the polyorganosiloxane compositions according to the invention may contain as component g) additional auxiliary substances typically used in single-component room temperature-vulcanizable polyorganosiloxane compositions (RTV-1K). Examples of these auxiliary substances include thickening agents or stabilizers such as phosphoric acid esters, complexing agents, antioxidants, adhesives such as organofunctional alkoxysilanes/siloxanes, reversion or hot air stabilizers (for example, chelates, salts, or oxides of Ti, Fe, or Ce), fungicides, inorganic or organic dyes or pigments, or conductive powder, glass spheres, or fibers, such as carbon black, metallized mineral powder, or metallic or graphite fibers.

Thus, the polyorganosiloxane compositions according to the invention are preferably produced by mixing and reacting the following components:
22 to 98.79% by weight polymer as component a)
0 to 15% by weight thickening agent as component b)
0.1 to 30% by weight crosslinker as component c)
0.1 to 30% by weight bonding agent or crosslinker as component d)
0 to 65% by weight inert filler as component e)
0.01 to 5% by weight catalyst as component f)
0 to 20% by weight auxiliary substances as component g), and
1 to 18% by weight of the alkylbenzenes according to the invention as component h),
where, in each case, the stated quantities are relative to the total amount of the polyorganosiloxane compositions a) through h).

It is practical to produce the polyorganosiloxane compositions according to the invention by mixing and reacting the referenced essential components a) through h), as well as the additional, optionally present components. The above-referenced components a) through h) of the inventive composition may be advantageously combined at temperatures of 20-90° C. by first mixing the components a) and c) and optionally d), allowing them to react, and then adding the remaining components. The crosslinkable polydiorganosiloxanes (component a) used according to the invention may optionally be produced in a separate process step or in situ in the preparation of the inventive polyorganosiloxane composition, for example by reacting an alpha, omega-hydroxyl-terminated polyorganosiloxane with at least two equivalents of an oximosilane/-siloxane crosslinker or benzamidosilane/siloxane crosslinker (component c). Furthermore, crosslinkable polyorganosiloxanes a) used according to the invention may also be obtained by reacting an alpha, omega-hydroxyl-terminated polyorganosiloxane with at least two equivalents of an aminoalkylalkoxysilane/-siloxane (component d). Thus, a sequence is preferred in which an alpha, omega-hydroxyl-terminated polyorganosiloxane is combined with the component c) or d). The automatically proceeding reaction with one embodiment of component a), the alpha, omega-hydroxyl-terminated polyorganosiloxane in the form of the starting product, results in the inventive reaction product of component a) produced in situ. If different components c) or d) are used, it is particularly preferred to first add the component c) or d) that reacts more rapidly with the alpha, omega-hydroxyl-terminated polyorganosiloxane to give the reaction product of component a). Only afterwards is it particularly preferred to add all remaining components such as b) through h). The sequence of addition of further components b) or e) through h) has no influence on the inventive effect of the coatablity or paintability.

The polyorganosilane [sic; polyorganosiloxane] or RTV-1K compositions according to the invention may be produced stepwise in a batch process or continuously with the use of extruders. Depending on the application, the compositions according to the invention may be regulated to be rigid or flowable by mixing, while excluding moisture and inerting with nitrogen, for example, in machines commonly used for RTV 1K, such as extruders, reciprocating mixers (Buss co-kneaders), kneaders, or, for example, planetary mixers, at 20 to 90° C. under a nitrogen atmosphere with the exclusion of moisture, and by introducing the thickening agent, in particular b), in a suitable manner according to the prior art.

The polyorganosiloxane compositions according to the invention are particularly suitable for producing one-component polyorganosiloxane compositions that are vulcanizable at room temperature. The polyorganosiloxane compositions vulcanized after the admission of moisture have elastomeric properties. The vulcanized polyorganosiloxane compositions are produced in such a way that the polyorganosiloxane compositions are allowed to come into contact with moisture in the ambient air at 0 to 120° C., preferably 0 to 100° C.

The polyorganosiloxane compositions according to the invention are particularly suitable for producing sealants, adhesives, molded bodies, profiles, coatings, or formed-in-place gaskets that may be painted or coated over in both the not yet crosslinked and the crosslinked states.

The vulcanized polyorganosiloxane compositions according to the invention are used for example as sealants/adhesives or coatings for joints, joining glass to mineral substrates, wood, or thermoplastics, profiled and molded gaskets, formed-in-place gaskets, or the coating of roofs or fabrics.

Consequently, the invention relates to uncured and cured (crosslinked, vulcanized) adhesives, joint sealants, molded bodies, profiles, or formed-in-place gaskets or coatings whose surfaces have at least a partial coating of paint.

According to DIN 52452, “paintability” is understood to mean the material property of a movement-compensating sealant that permits a manually and optically satisfactory maximum overlapping border of 2 mm with the paint material on the sealant in a joint without adverse interactions between the sealant, paint material, and/or the contiguous construction elements.

On the other hand, in the sense of the invention, the concept of coatability encompasses the material property of being able to apply one or more coats of paint on a movement-compensating sealant without adverse interactions of a functional or optical type, the following requirements preferably being met:
1) Defect-free coating of the sealant surface, i.e., no wetting interferences,
2) Satisfactory thorough drying of the paint,
3) No change in color of the paint,
4) Expansibility according to the permissible total deformation of the sealant, without crack formation in the paint and with good paint adhesion, and
5) In addition, low volume shrinkage (<8% by volume) according to the invention.

The layer thicknesses of the paints or painted materials on the elastomeric polyorganosiloxane compositions are typically 1 μm to 1000 μm.

In general, paints are liquid, paste, or powdered coating substances that, when applied to a substrate, result in an overlying coating having protective, decorative, or specific technical properties (DIN 971-1 (September 1996)).

Conventional, solvent-based paints include all paints that contain natural (i.e., of plant or animal origin) or synthetic solvents. Alkyd resin paints, which are understood to be paints in accordance with DIN 55945 (August 1983) and which contain alkyd resins as characteristic film-forming agents, are typical, widely used representatives of solvent-based paints. DIN 53183 (September 1973) defines alkyd resins as polyester resins that have been modified with natural fats and oils and/or synthetic fatty acids and produced by esterification of multivalent alcohols (of which at least one must be trivalent) with polycarboxylic acids. Thus, alkyd resins may be produced by esterification of di- and polyfunctional alcohols (for example, ethylene glycol, 1,2-propylene glycol, glycerin, trimethylolpropane, pentaerythrite, and dipentaerythrite) with dicarboxylic acids (for example, phthalic, isophthalic, terephthalic, maleic, adipic, and dimer fatty acids) or their anhydrides, and saturated or unsaturated fatty acids. (Also see Ullmann's Encyclopedia of Industrial Chemistry, 6th Ed. 2001, electronic release, keyword ‘alkyd*,’ etc.) Alkyd resin paints vary greatly in their solvent content, and, depending on the curing mechanism, encompass air-drying paints (oxidative crosslinking via olefinic double bonds, such as artist's paint) and heat-curable paints (crosslinking via condensation reactions, such as enamels).

Water-based or water-dilutable paints are described in DIN 55945 (September 1996), and may contain small quantities of organic solvent. They include acrylic latex dispersion paints for paint work, for example.

### EXAMPLES

The following examples serve to illustrate the invention without limiting same.

The polyorganosiloxanes were produced in the sequence described below in 1-liter planetary mixers (from Drais) or 20-liter planetary dissolvers (from Linden), according to examples presented below. The individual components were mixed at 5-minute intervals (unless stated otherwise) at temperatures between 25 and 60° C. under dried nitrogen. After production was completed the mixture was freed of occluded bubbles by continued stirring under slight vacuum. The polyorganosiloxane compositions were then filled into airtight sealable plastic cartridges for use in comparative tests.

### Example 1

A silicone rubber mixture was produced according to the following formulation:
1) 44.5 parts by weight of a linear alpha, omega-hydroxyl-terminated polydimethylsiloxane having a viscosity of 80 Pa.s at 25° C. (shear rate gradient D=1s⁻¹)
2) 10.0 parts by weight of a mixture of monoalkylbenzenes as component h) having a density of 0.87 g/mL at 15° C., a kinematic viscosity of 58 mm²/s at 40° C., an initial boiling point of 335° C., an average molecular weight of 350 g/mol, an aniline point of 68° C., and a VDC of 0.890, marketed under the trade name “Progyline 150 B” by Shrieve Products International Ltd.
3) 0.5 parts by weight tris(methylethylketoximo)vinyl silane as component c) (followed by 10 minutes mixing time)
4) 4.0 parts by weight methyl-tris(methylethylketoximo)silane as component c)
5) 35.0 parts by weight ground chalk (CaCO₃) that had been surface-treated with stearic acid and used as component e)
6) 4.5 parts by weight hydrophilic silicic acid as component b), marketed under the trade name Aerosil® 150 by Degussa
7) 1.5 parts by weight of a mixture composed of 0.5 parts by weight N-(2-aminoethyl)-3-aminopropyltrimethoxysilane and 1.0 part by weight of an alpha, omega-bis(diethoxy-3-propylamine)-terminated dodecamethylhexasiloxane, which was used as component d), and
8) 0.1 parts by weight of the product from a reaction of 83.8 parts by weight dibutyl tin oxide and 116.2 parts by weight aminopropyltrimethoxysilane as component f).

The silicone rubber mixture thus produced was homogeneous, flexible, soft, and stable (Boeing flow test: 0 mm). Additional typical properties of this paste, or the elastomer obtained by vulcanization, are presented in Table 1. The RTV-1 composition exhibited very good adhesion to PVC substrates. To test stability in storage, samples of this formulation were filled into aluminum tubes, sealed airtight, and stored at 70° C. to enable evaluation of stability in storage as measurable crosslinkability after accelerated aging. After 20 weeks'storage at 70° C., the tubes were cooled to room temperature, and test plates 2 mm thick were prepared from the sealing composition. The rubber mechanical data were evaluated on glass test samples in accordance with DIN 52455. The paste exhibited normal thorough curing behavior under standard environmental conditions (room temperature 25° C., 50% relative humidity).

TABLE 1
Properties of the RTV-1K composition according to the
formulation from Example 1

| | Results |
|---|---|
| | from |
| | Example 1 |
| Property | |
| Appearance/color | White |
| Specific gravity (g/mL) | 1.27 |
| Flow behavior according to Boeing flow test (mm) | 0 |
| Extrusion rate at 2 bar and 6 mm nozzle diameter (g/min) | 185 |
| Surface crosslinking time (min) | 6 |
| Hardness in accordance with DIN 53505 (° Shore A) | 34 |

Mechanical properties of glass test samples in
accordance with DIN 52455:

| | |
|---|---|
| Tensile stress at 100% elongation at break (N/mm²) | 0.36 |
| Tearing strength at rupture (N/mm²) | 0.37 |
| Elongation at break (%) | 150 |
| Volume shrinkage under ISO 10563 (%) | 6.1 |
| Mass shrinkage, storage at 120° C., 24 hours (%) | 5.5 |
| Adhesion test under ASTM c-794 (N/mm/% CF*): | 6.9/100 |
| on polyvinyl chloride (PVC) (from Kommerling) | |

*CF = cohesive failure with respect to adhesive layer

The paint adhesion was tested in accordance with ASTM (American Society for Testing and Materials) D-3359-78 by allowing the test paints to completely dry on the sealant material test plates over a period of 2 weeks, dividing the paint surface into square sections (2.5 mm edge length) using a blade, then covering the cut paint surface with adhesive tape and rapidly pulling off the tape at a 180° angle. Without exception, all tested paints adhered very well (100%) to the inventive silicone vulcanizate.

The volume shrinkage determined in accordance with ISO 10563 (4 weeks storage under standard environmental conditions, followed by 7 days at 70° C., followed by 1 day again under standard environmental conditions) was only 6.1%.

The results of the paintability and coatability tests are shown in Table 3 below.

### Example 2

A silicone rubber mixture was produced according to Example 1, except that, instead of 10.0 parts by weight of a mixture of monoalkylbenzenes having a density of 0.87 g/mL at 15° C., a kinematic viscosity of 58 mm²/s at 40° C., an initial boiling point of 335° C., and an average molecular weight of 350 g/mol, 10.0 parts by weight of a mixture of various isomers of essentially linear dialkylbenzenes having a density of 0.87 g/mL at 25° C., a kinematic viscosity of 17.9 mm²/s at 40° C., an initial boiling point of 330° C., an average molecular weight of 330 g/mol, an aniline point of 52.5° C., and a VDC of 0.914, marketed under the trade name “Alchisor 3 SP” by Sasol Italy S.p.A. was used.

The silicone rubber mixture thus produced was homogeneous, flexible, soft, and stable (Boeing flow test: 0 mm). In the test for paintability or coatability, a very good paint profile (see Table 3) and a very good paint adhesion in accordance with ASTM D-3359-78 were determined. Without exception, all paints tested adhered very well (100%) to the silicone vulcanizate.

Additional properties of the silicone elastomer:
Tensile stress at 100% elongation: 0.43 N/mm²,
Tear strength: 0.43 N/mm²,
Elongation at break: 106%,
Shore A hardness: 34°,
Volume shrinkage (ISO 10563): 6.0%
Mass shrinkage (storage at 120° C., 24 hours): 5.9%

### Example 3

A silicone rubber mixture was produced according to Example 1, except that, instead of 10.0 parts by weight of a mixture of monoalkylbenzenes having a density of 0.87 g/mL at 15° C., a kinematic viscosity of 58 mm²/s at 40° C., an initial boiling point of 335° C., and an average molecular weight of 350 g/mol, 10.0 parts by weight of a mixture of various linearers of branched-chain mono- and polyalkylbenzenes having a density of 0.87 g/mL at 15° C., a kinematic viscosity of 40-48 cSt at 40° C., an initial boiling point of 330° C., an average molecular weight of 365 g/mol, an aniline point of 64-66° C., and a VDC of 0.893-0.896 marketed under the trade name HAL 47 by Janex S.A. was used.

The silicone rubber mixture thus produced was homogeneous, flexible, soft, and stable (Boeing flow test: 0 mm). In the test for paintability or coatability a very good paint profile (see Table 3) and a very good paint adhesion in accordance with ASTM D-3359-78 were determined. Without exception, all paints tested adhered very well (100%) to the silicone vulcanizate.

Additional properties of the silicone elastomer:
Tear strength: 0.40 N/mm²,
Shore A hardness: 32,
Volume shrinkage (ISO 10563): 7.5%,
Mass shrinkage (storage at 120° C., 24 hours): 4.9%

### Example 4

A silicone rubber mixture was produced according to Example 1, except that, instead of 10.0 parts by weight of a mixture of monoalkylbenzenes having a density of 0.87 g/mL at 15° C., a kinematic viscosity of 58 mm²/s at 40° C., an initial boiling point of 335° C., and an average molecular weight of 350 g/mol, 10.0 parts by weight of a mixture of 70% long-chain alkylbenzenes and 30% linear and branched paraffins (C₁₄H₃₀ to C₂₆H₅₄) having an overall density of 0.84 g/mL at 15° C., a kinematic viscosity of 12 mm^{2/}s at 40° C., an initial boiling point of approximately 270° C., an aniline point of 76° C., and a VDC of 0.878 marketed under the trade name “SHR 105” by Shrieve Products International Ltd. was used.

The silicone rubber mixture thus produced was homogeneous, flexible, soft, and stable (Boeing flow test: 0 mm). In the test for paintability or coatability a very good paint profile (see Table 3) and a very good paint adhesion in accordance with ASTM D-3359-78 were determined. Without exception, all paints tested adhered very well (100%) to the silicone vulcanizate.

Additional properties of the silicone elastomer:
Tear strength: 0.39 N/mm²,
Shore A hardness: 34,
Volume shrinkage (ISO 10563): 11.2%
Mass shrinkage (storage at 120° C., 24 hours): 7.2%

As a result of the 30% proportion of paraffins in the hydrocarbon mixture used, the volume shrinkage was slightly increased compared to the values found in Examples 1 through 3.

### Example 5, Comparative

A silicone rubber mixture was produced according to Example 1, except that, instead of 10.0 parts by weight of a mixture of monoalkylbenzenes having a density of 0.87 g/mL at 15° C., a kinematic viscosity of 58 mm²/s at 40° C., an initial boiling point of 335° C., and an average molecular weight of 350 g/mol, 10.0 parts by weight of a mixture of linear and branched-chain paraffins (C₁₂H₂₆ to C₂₆H54) having a density of 0.78 g/mL at 15° C., a kinematic viscosity of 5.1 cSt at 20° C., an initial boiling point of 250° C, an average molecular weight of 212 g/mol, an aniline point of 95° C., and a VDC of 0.852 (which was outside the claimed region), marketed under the trade name Alchisor S by Sasol Italy S.p.A. was used.

The silicone rubber mixture thus produced was homogeneous, flexible, soft, and stable (Boeing flow test: 0 mm). In the test for paintability and coatability, no satisfactory results were obtained with water-based paints (see Table 3). The volume shrinkage of 21.8%, determined in accordance with ISO 10563, was significantly increased compared to the values found in Examples 1 through 3.

Additional properties of the silicone elastomer:
Tear strength: 0.41 N/mm²,
Elongation at break: 77%,
Shore A hardness: 34,
Mass shrinkage (storage at 120° C., 24 hours): 14.0%,
Volume shrinkage (ISO 10563): 21.8%

### Example 6, Comparative

A silicone rubber mixture was produced according to Example 1, except that, instead of 10.0 parts by weight of a mixture of monoalkylbenzenes having a density of 0.87 g/mL at 15° C., a kinematic viscosity of 58 mm²/s at 40° C., an initial boiling point of 335° C., and an average molecular weight of 350 g/mol, 10.0 parts by weight of an alpha, omega-trimethyl-terminated polydimethylsiloxane having a viscosity of 100 mPa.s at 25° C. (shear rate gradient D=1s⁻¹) was used.

The silicone rubber mixture thus produced was homogeneous, flexible, soft, and stable (Boeing flow test: 0 mm). In the test for paintability or coatability, no satisfactory results were obtained with water-based paints, and even the flow of the solvent-based paints was poorer (see Table 3).

Additional properties of the silicone elastomer:
Tensile stress at 100% elongation: 0.40 N/mm²,
Tear strength: 0.41 N/mm²,
Elongation at break: 110%,
Shore A hardness: 32,
Volume shrinkage (ISO 10563): 5.9%
   Test Results

To test the paintability or coatability of the polyorganosiloxane compositions produced in the examples and comparative examples 1 through 5, a sealant material test plate 2 mm thick was withdrawn and cured in a climate-controlled room (room temperature, 50% relative humidity). After one day (24 hours) and after 7 days, in each case, a series of eight commercially available oil- and water-based paints was applied to the coat:
1) Water-based paint: “Aquawood DSC farblos [colorless] E-Statik,” colorless, from Adlerwerk, paint works, A-6130 Schwaz
2) Water-based acrylic wood varnish, walnut, water-dilutable, from Glasurit GmbH, 48138 Münster
3) Water-based paint: “Sigma S2U nova satin,” white, from Sigma Coatings, 1422 AD Uithoorn, Netherlands
4) Water-based paint: “Sigma S2U nova satin,” blue, from Sigma Coatings, 1422 AD Uithoorn, Netherlands
5) Water-based acrylic paint: “Permacryl,” black, high-gloss, microporous, from Trimetal Paints, 6222 AA Mastricht, Netherlands
6) Water-based acrylic paint: “Bunt-Acryl,” gentian blue, water-dilutable, from OBI Systemzentrale, 42929 Wermelskirchen
7) Solvent-containing, oil-based alkyd resin paint: “Sigma schakelverf,” white, from Sigma Coatings, 1422 AD Uithoorn
8) Solvent-containing, oil-based paint: “Seiden-Herbol®, Herbosatin,” silk gray, from Akzo Nobel Deco GmbH, 50827 Cologne

After approximately 12 hours drying time, the paint profile on the test plate, the sealant coat, was evaluated according to the following criteria:

TABLE 2
Evaluation criteria for the paint profile

| Quality of | | |
|---|---|---|
| paint flow: | Evaluation | Description |
| 0 | Poor paint flow | No adherent paint surface, |
| | | <50% wetting |
| 1 | Moderate paint flow | Cracks and dewetting in the |
| | | paint surface, 50-85% wetting |
| 2 | Good paint flow | Only small cracks in the |
| | | adherent paint surface, |
| | | 85-99% wetting |
| 3 | Very good paint flow | Complete wetting of the sealant |
| | | surface, >99% wetting |

For all oil- and water-based paints used, complete wetting of the sealant surfaces was observed in the polyorganosiloxane compositions according to the invention (see Table 3), whereby the vulcanization time (1 or 7 days) had no effect on the paint flow. In all cases, the paints applied to the vulcanizate dried thoroughly without defects in a maximum time of 2 hours, did not discolor, and also exhibited no wrinkling, i.e., “ripple” formation, on the paint surface.

In contrast, for most of the paints, the comparative examples 5 and 6 showed no adherent paint surface, or showed crack formation.

TABLE 3
Summary of paint flows

| | | From Example: | | | | | | | | | | | |
|---|---|---|---|---|---|---|---|---|---|---|---|---|---|
| | | | | | | | | | | 5 | | 6 | |
| | | 1 | | 2 | | 3 | | 4 | | (Comp.) | | (Comp.) | |
| | | After . . . day(s) | | | | | | | | | | | |
| Paint No.: | | 1 | 7 | 1 | 7 | 1 | 7 | 1 | 7 | 1 | 7 | 1 | 7 |
| 1) | Water- | 3 | 3 | 3 | 3 | 3 | 3 | 3 | 3 | 2 | 2 | 2 | 2 |
| | based | | | | | | | | | | | | |
| 2) | Water- | 3 | 3 | 2 | 3 | 2 | 2 | 3 | 2 | 0 | 0 | 0 | 0 |
| | based | | | | | | | | | | | | |
| 3) | Water- | 3 | 3 | 3 | 3 | 3 | 3 | 3 | 3 | 2 | 2 | 2 | 3 |
| | based | | | | | | | | | | | | |
| 4) | Water- | 3 | 3 | 3 | 3 | 3 | 3 | 3 | 3 | 0 | 0 | 2 | 2 |
| | based | | | | | | | | | | | | |
| 5) | Water- | 3 | 3 | 3 | 3 | 3 | 2 | 3 | 3 | 0 | 0 | 0 | 0 |
| | based | | | | | | | | | | | | |
| 6) | Water- | 3 | 3 | 3 | 3 | 2 | 2 | 3 | 2 | 0 | 0 | 1 | 0 |
| | based | | | | | | | | | | | | |
| 7) | Solvent- | 3 | 3 | 3 | 3 | 3 | 3 | 3 | 3 | 3 | 3 | 3 | 3 |
| | based | | | | | | | | | | | | |
| 8) | Solvent- | 3 | 3 | 3 | 3 | 3 | 3 | 3 | 3 | 3 | 3 | 2 | 2 |
| | based | | | | | | | | | | | | |

### Example 7, Comparative

A silicone rubber mixture was produced according to Example 1, except that, instead of 10.0 parts by weight of a mixture of monoalkylbenzes having a density of 0.87 g/mL at 15° C., a kinematic viscosity of 58 mm²/s at 40° C., an initial boiling point of 335° C., and an average molecular weight of 350 g/mol, 10.0 parts by weight of a mixture of branched-chain monoalkylbenzenes having a density of 0.87 g/mL at 15° C., a kinematic viscosity of 380 cSt at 40° C., an initial boiling point of 295° C., an average molecular weight of 600 g/mol (not according to the invention), an aniline point of 103.0° C., and a VDC of 0.836 (outside the claimed region of the invention), marketed under the trade name “HAL 39” by Janex S.A. was used.

The vulcanized sealant material test plate, 2 mm thick and cured under standard environmental conditions (room temperature, 50% relative humidity), was observed immediately after being produced and exhibited heavy sweating of the monoalkylbenzes used. Therefore, this silicone rubber mixture is not suitable for use as a sealant in the sense of the invention, which, in addition, should have a low volume shrinkage.

### Example 8

Silicone rubber mixtures were produced according to Example 1, except that, instead of 10.0 parts by weight, 5.0 parts by weight (formulation 8A), 15.0 parts by weight (formulation 8B), or 20 parts by weight (formulation 8C) of a mixture of monoalkylbenzenes having a density of 0.87 g/mL at 15° C., a kinematic viscosity of 58 mm²/s at 40° C., an initial boiling point of 335° C., an average molecular weight of 350 g/mol, an aniline point of 68° C., and a VDC of 0.890, marketed under the trade name “Progyline 150 B” by Shrieve Products International Ltd., was used.

All of the silicone rubber mixtures thus produced were homogeneous, flexible, and soft. Although the RTV-1K compositions of formulations A and B were non-sagging (both Boeing flow tests: 0 mm), formulation C resulted in a slightly flowable composition (Boeing flow test: 5 mm). In the test for paintability or coatability, the vulcanizates of the mixtures containing 5 to 15 parts by weight alkylbenzenes exhibited good to very good paint flows (see Table 4), but only one water-based acrylic paint (paint No. 5) for the vulcanizate of the mixture containing 15 parts by weight of the described alkylbenzene exhibited only 80% wetting.

TABLE 4
Summary of paint flows

| | From Example: | | | | | | | |
|---|---|---|---|---|---|---|---|---|
| | 8A | | 1 | | 8B | | 8C | |
| | Parts by weight of the alkylbenzenes | | | | | | | |
| | 5.2% | | 10.0% | | 14.3% | | 18.2% | |
| | After . . . day(s) | | | | | | | |
| Paint No.: | 1 | 7 | 1 | 7 | 1 | 7 | 1 | 7 |
| 1) Water-based | 3 | 3 | 3 | 3 | 3 | 3 | — | — |
| 2) Water-based | 2 | 3 | 3 | 3 | 2 | 2 | — | — |
| 3) Water-based | 3 | 3 | 3 | 3 | 3 | 3 | — | — |
| 4) Water-based | 2 | 3 | 3 | 3 | 2 | 3 | — | — |
| 5) Water-based | 2 | 2 | 3 | 3 | 1 | 1 | — | — |
| 6) Water-based | 2 | 3 | 3 | 3 | 2 | 2 | — | — |
| 7) Solvent-based | 3 | 3 | 3 | 3 | 3 | 3 | — | — |
| 8) Solvent-based | 3 | 3 | 3 | 3 | 3 | 3 | — | — |

Formulation A:
Tear strength: 0.42 N/mm²,
Elongation at break: 80%,
Shore A hardness: 36°,
Volume shrinkage (ISO 10563): 6.9%

Formulation B:
Tensile strength at 100% elongation: 0.29 N/mm²,
Tear strength: 0.31 N/mm²,
Elongation at break: 150%,
Shore A hardness: 25,
Volume shrinkage (ISO 10563): 6.3%

Formulation C:
Tensile strength at 100% elongation: 0.24 N/mm²,
Tear strength: 0.29 N/mm²,
Elongation at break: 220%,
Shore A hardness: 21,
Volume shrinkage (ISO 10563): 5.6%
   measured on a vulcanized sealant material test plate, 2 mm thick and cured under standard environmental conditions (room temperature, 50% relative humidity), were observed after approximately one day and showed sweating of the monoalkylbenzenes used. Therefore, this silicone rubber mixture is not suitable for use as a sealant.

### Example 9, Comparative

A silicone rubber mixture was produced according to Example 1, except that, instead of 1.5 parts by weight of a mixture composed of 0.5 parts by weight N-(2-aminoethyl)-3-aminopropyltrimethoxysilane and 1.0 part by weight of an alpha, omega-bis(diethoxy-3-propylamine)-terminated dodecamethylhexasiloxane (both as component d)), 1.5 parts by weight tris[3-(trimethoxysilyl)propyl]-isocyanurate was used as component d).

The silicone rubber mixture thus produced was homogeneous, flexible, soft, and stable (Boeing flow test: 0 mm). In the test for paintability or coatability, no satisfactory results were obtained with water-based paints (see Table 5).

Additional properties of the silicone elastomer:
Tear strength: 0.44 N/mm²,
Elongation at break: 90%,
Shore A hardness: 36,

Volume shrinkage (ISO 10563): 6.1%

TABLE 5
Summary of paint flows

| From Example: | |
|---|---|
| 9 | |
| (Comp.) | 1 |

After . . . day(s)

| Paint No.: | 1 | 7 | 1 | 7 |
|---|---|---|---|---|
| 1) Water-based | 1 | 1 | 3 | 3 |
| 2) Water-based | 0 | 0 | 3 | 3 |
| 3) Water-based | 3 | 1 | 3 | 3 |
| 4) Water-based | 1 | 1 | 3 | 3 |
| 5) Water-based | 0 | 0 | 3 | 3 |
| 6) Water-based | 0 | 0 | 3 | 3 |
| 7) Solvent-based | 3 | 3 | 3 | 3 |
| 8) Solvent-based | 3 | 3 | 3 | 3 |

### Examples 10A and 10B, Comparative

As a comparison, silicone rubber mixtures were produced with the exchange of component c), based on other “neutral” (i.e., not forming acids upon crosslinking) alkoxy crosslinkers (formulation A) and based on acid-forming acetate crosslinkers (formulation B) according to the following formulations, which, likewise, contained monoalkylbenzenes.

Formulation 10A:
1) 45.0 parts by weight of an alpha, omega-hydroxyl-terminated polydimethylsiloxane having a viscosity of 80 Pa.s at 25° C. (shear rate gradient D=1s⁻¹) (component a))
2) 10.0 parts by weight of a mixture of monoalkylbenzenes having a density of 0.87 g/mL at 15° C., a kinematic viscosity of 58 mm²/s at 40° C., an initial boiling point of 335° C., and an average molecular weight of 350 g/mol, marketed under the trade name “Progyline 150 B” by Shrieve Products International Ltd. (component h))
3) 1.5 parts by weight of a mixture of mono- and bis(2-ethylhexyl)-phosphoric acid esters (stabilizers as component g))
4) 45.0 parts by weight precipitated chalk (CaCO₃) that had been surface-treated with stearic acid (component e))
5) 3.0 parts by weight methyltrimethoxysilane (component c), not according to the invention)
6) 0.5 parts by weight methanol (component g))
7) 1.0 part by weight bis(1,3-propanedioxy)-titanium(IV)acetylacetonate ethylacetoacetate (component f)) and
8) 3.0 parts by weight N-(2-aminoethyl)-3-aminopropyltrimethoxysilane (component d))

Formulation 10B:
1) 86.0 parts by weight of a linear alpha, omega-hydroxyl-terminated polydimethylsiloxane having a viscosity of 80 Pa.s at 25° C. (shear rate gradient D=1s⁻¹) as component a)
2) 10.0 parts by weight of a mixture of monoalkylbenzenes having a density of 0.87 g/mL at 15° C., a kinematic viscosity of 58 mm²/s at 40° C., an initial boiling point of 335° C., and an average molecular weight of 350 g/mol, marketed under the trade name “Progyline 150 B” by Shrieve Products International Ltd. (component h))
3) 3.7 parts by weight ethyltriacetoxysilane (component c)) (not according to the invention)
4) 0.4 parts by weight bis(tert-butoxy)-diacetoxysilane (bonding agent, component d)) (not according to the invention)
5) 9.5 parts by weight hydrophilic silicic acid, marketed under the trade name Aerosil® 150 by Degussa (component b)) and
6) 0.01 parts by weight dibutyl tin acetate (component f))

The silicone rubber mixtures thus produced were homogeneous, flexible, soft, and stable (Boeing flow test: 0 mm in each case). In the test for paintability or coatability, no satisfactory results were obtained (see Table 6). Despite the absence of an alpha, omega-trimethyl-terminated polydimethylsiloxane, otherwise common in RTV 1K, in the formulations, and despite the use of the alkylbenzenes according to the invention, in a filled alkoxy system such as 10A (alkoxy crosslinker, component c), not according to the invention) and in an acetate system such as 10B (acetate crosslinker, component c), not according to the invention), no satisfactory wetting of the paints was achieved.

Additional properties of the silicone elastomer produced according to 10A:
Tensile stress at 100% elongation: 0.16 N/mm²,
Tear strength: 0.59 N/mm²,
Elongation at break: 659%,
Shore A hardness: 11,
Volume shrinkage (ISO 10563): 4.1%,
Mass shrinkage (storage at 120° C., 24 hours): 3.7%

### Example 10C

A silicone rubber mixture based on an additional inventive neutral benzamide crosslinker according to formulation C was produced.
1) 49.8 parts by weight of a linear alpha, omega-hydroxyl-terminated polydimethylsiloxane as component a), having a viscosity of 80 Pa.s at 25° C. (shear rate gradient D=1s⁻¹)
2) 10.0 parts by weight of a mixture of monoalkylbenzenes having a density of 0.87 g/mL at 15° C., a kinematic viscosity of 58 mm²/s at 40° C., an initial boiling point of 335° C., and an average molecular weight of 350 g/mol, marketed under the trade name “Progyline 150 B” by Shrieve Products International Ltd.
3) 2.0 parts by weight of an alpha, omega-bis(diethoxy-3-propylamine)-terminated dodecamethylhexasiloxane as component d)
4) 30.0 parts by weight ground chalk (CaCO₃) as component e) that had been surface-treated with stearic acid
5) 3.5 parts by weight bis(N-methylbenzamido)-ethoxymethylsilane (component c))
6) 4.5 parts by weight hydrophobic silicic acid as component b), marketed under the trade name Aerosil®) 150 by Degussa and
7) 0.2 parts by weight of the product of a reaction of dioctyl tin oxide and tetrapropylsilicate (45 to 55 parts by weight as component f))

The silicone rubber mixture thus produced was homogeneous, flexible, soft, and stable (Boeing flow test: 0 mm). In the test for paintability or coatability, a very good paint flow (see Table 6) and a very good paint adhesion (in accordance with ASTM D-3359-78) were determined.

Additional properties of the 10C silicone elastomer:
Tensile stress at 100% elongation: 0.35 N/mm²,
Tear strength: 0.35 N/mm²,
Elongation at break: 116%,
Shore A hardness: 26,
Volume shrinkage (ISO 10563): 4.7%,

Mass shrinkage (storage at 120° C., 24 hours): 5.4%

TABLE 6
Summary of paint flows

| | From Example: | | | | | | | |
|---|---|---|---|---|---|---|---|---|
| | 10, A | | 10, B | | | | | |
| | (Comp.) | | (Comp.) | | 10, C | | 1 | |
| | After . . . day(s) | | | | | | | |
| | 1 | 7 | 1 | 7 | 1 | 7 | 1 | 7 |
| | Crosslinker system | | | | | | | |
| Paint No.: | Alkoxy | | Acetate | | Benzamide | | Oxime | |
| 1) Water-based | 2 | 2 | 1 | 1 | 3 | 3 | 3 | 3 |
| 2) Water-based | 1 | 0 | 0 | 0 | 3 | 2 | 3 | 3 |
| 3) Water-based | 3 | 3 | 0 | 0 | 3 | 3 | 3 | 3 |
| 4) Water-based | 3 | 2 | 0 | 0 | 3 | 3 | 3 | 3 |
| 5) Water-based | 0 | 0 | 0 | 0 | 3 | 2 | 3 | 3 |
| 6) Water-based | 2 | 0 | 0 | 0 | 3 | 3 | 3 | 3 |
| 7) Solvent-based | 3 | 2 | 3 | 3 | 3 | 3 | 3 | 3 |
| 8) Solvent-based | 3 | 3 | 3 | 3 | 3 | 3 | 3 | 3 |

### Example 11, Comparative

A silicone rubber mixture according to DE 3 025 376 was produced according to Example 1, except that instead of 10.0 parts by weight of a mixture of monoalkylbenzenes having a density of 0.87 g/mL at 15° C., a kinematic viscosity of 58 mm²/s at 40° C., an initial boiling point of 335° C., and an average molecular weight of 350 g/mol as component h), 10.0 parts by weight cyclohexane was used.

The silicone rubber mixture thus produced was homogeneous, flexible, soft, and stable (Boeing flow test: 0 mm). The volume shrinkage of 17.1%, determined in accordance with ISO 10563, was significantly increased compared to the values found in Examples 1 through 3 (see Table 7). Therefore, the use of cyclohexane as an additive for adjusting the coatability does not completely achieve the object of the invention, since the volume shrinkage is too high.

Additional properties of the silicone elastomer:
Tear strength: 0.51 N/mm²,
Elongation at break: 60%,
Shore A hardness: 45,

Volume shrinkage (ISO 10563): 17.1%

TABLE 7
Comparison of volume shrinkage values (ISO 10563)

| | From | Volume |
|---|---|---|
| Hydrocarbon used | Example: | shrinkage (%) |
| Cyclohexane | 11 | 17.1 |
| Linear and branched-chain paraffins | 5 | 21.8 |
| Monoalkylbenzenes | 1 | 6.1 |
| Essentially linear dialkylbenzenes | 2 | 6.0 |
| Branched-chain mono- and | 3 | 7.5 |
| polyalkylbenzenes | | |

1. Polyorganosiloxane composition that is obtainable by a method comprising the mixing and reacting of the following components:
a) At least one crosslinkable polyorganosiloxane,
b) Optionally, a filler for thickening or reinforcing,
c) At least one crosslinker selected from the group consisting of oximosilane/-siloxane crosslinkers and benzamidosilane/-siloxane crosslinkers,
d) At least one aminoalkylalkoxysilane or -siloxane,
e) Optionally, an inert filler,
f) At least one organometallic catalyst,
g) Optionally for RTV-1K compositions, common auxiliary substances, and
h) 1 to 18% by weight alkylaromatic compounds, relative to the total weight of the composition, having an average molar mass of 200 to 500 g/mol in the particular compound class, and a viscosity-density constant (VDC) of at least 0.860.

2. Polyorganosiloxane composition according to claim 1, wherein the component a) is at least one compound of the formula 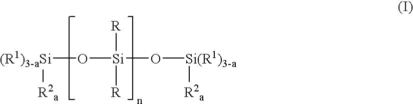
where R and R² are the same or different, and, in each case, independently represent optionally substituted C₁-C₁₀ alkyl, C₆-C₁₄ aryl, or C₂-C₁₀ alkenyl groups, and R, in addition to the foregoing, further represents R²₂SiO, R¹₃₋ₐSiO_{0.5}, R²SiO_{3.2}, or Q=SiO_{4/2}, whereby R¹ in each case independently represents hydrolyzable groups, n is a whole number from 50 to 2500, and a=0, 1, or 2.

3. Polyorganosiloxane composition according to claim 1 wherein said crosslinker is selected from the group consisting of organosilicon compounds that contain at least two ≡Si—O—N═CR⁵₂ and/or ≡Si—N(R²)—C(═O)R⁵ groups and alkoxy groups (—OR²), and wherein R² and R⁵ independently represent optionally substituted C₁-C₁₀ alkyl, C₆-C₁₄ aryl, or C₂-C₁₀ alkenyl groups.

4. Polyorganosiloxane composition according to claim 1, wherein said aminoalkylalkoxysilane/-siloxane has the formulas (III) and/or (IV)
X—(CH₂)_{c}—Si(OR⁶)₃ (III)
X—(CH₂)_{C}—Si(OR⁶)₂—O[Me₂SiO]ₙ Si(OR⁶)₂—(CH₂)_{c}—X (IV)
where X is selected from —NH₂, —NHR⁶, —NR⁶₂—NHCH₂CH₂NH₂, and where R⁶, in each case independently represents optionally substituted linear or cyclic C₁-C₁₀ alkyl, C₆-C₁₄ aryl, C₂-C₁₀ alkenyl, or siloxane groups, where c is a whole number between 2 and 10.

5. Vulcanized elastic polyorganosiloxane compositions that are obtainable by reacting the polyorganosiloxane compositions through contact with water or water vapor at temperatures of 0 to 100° C. according to claim 1.

6. Joint sealants, adhesives, molded bodies, flows, coatings, and formed-in-place gaskets comprising the polyorganosiloxane composition of claim 1.

7. The joint sealants, adhesives, flows, molded bodies, coatings, and formed-in-place gaskets according to claim 6, wherein same are paintable or coatable in both the uncrosslinked and the crosslinked states.

8. Molded bodies, joint sealants, flows, coatings, or formed-in-place gaskets according to claim 5, the surfaces of which have at least a partial coating of paint.

9. The Polyorganosiloxane composition of claim 3, wherein c represents the number 3.
